(19) United States
(12) Patent Application Publication
(10) Pub. No.: US 2007/0243372 A1
(43) Pub. Date: Oct. 18, 2007

(54) AQUEOUS ADHESIVE

(76) Inventors: Douglas H. Mowrey, Titusville, PA (US); James Biron Williams, Erie, PA (US); Stuart Edward Armstrong, Chapel Hill, NC (US); Thomas Christian Gaadt, Erie, PA (US)

Correspondence Address: LORD CORPORATION;PATENT & LEGAL SERVICES, 111 LORD DRIVE, CARY, NC, 27512, US

(21) Appl. No.: 11/734,808

(22) Filed: Apr. 13, 2007

Related U.S. Application Data
(60) Provisional application No. 60/791,751, filed on Apr. 13, 2006.

(51) Int. Cl. B32B 27/42; B32B 27/08; B32B 25/16; B32B 25/08

(52) U.S. Cl. 428/336; 428/525; 428/506; 428/521; 156/307.5

(57) ABSTRACT

A two coat adhesive system containing an undercoat having a flexibilizer, a phenolic resin, and an acid; and, a covercoat containing an aqueous phenolic resin, and an aqueous butadiene polymer latex prepared by emulsion polymerization of at least one butadiene monomer in the presence of a polyvinvyl alcohol.

### CROSS REFERENCE

This application claims the benefit of, and incorporates by reference, U.S. Provisional Patent Application No. 60/791,751 filed Apr. 13, 2006.

### FIELD OF THE INVENTION

The present invention relates to an autodepositable adhesive, particularly an adhesive for bonding an elastomeric material to a metallic material.

### BACKGROUND OF THE INVENTION

It is generally known that the corrosion resistance of metal substrates can be improved by coating the substrate with an autodeposition composition that generally comprise an aqueous solution of an acid, an oxidizing agent and a dispersed resin. Immersion of a metallic surface in an autodeposition composition produces what is said to be a self-limiting protective coating on a metal substrate.

Elastomer-to-metal bonding is subjected to severe environmental conditions in many industrial and automotive assemblies. For example, many engine mounting assemblies that employ elastomer-to-metal bonding contain fluids in order to assist in damping of vibration of the engine. These fluid-filled engine mounting devices are being increasingly exposed to high temperatures such that the elastomer-to-metal adhesive bonds within the mounts are being exposed to very high temperature fluid environments. Many elastomer-to-metal assemblies, particularly those utilized in automobile applications, are routinely exposed to materials that contain corrosive salts or other corrosive materials that may act to degrade the elastomer-to-metal adhesive bond.

In light of the increasing regulations regarding volatile organic compounds (VOC), the use of traditional solvent-borne adhesives is becoming more problematic. Consequently, there is significant ongoing work to develop water-borne replacements. Current aqueous adhesives suffer from user drawbacks. Application of an adhesive by dipping the part in a bath of the adhesive is frequently preferred by the user due to its simplicity. However, dipping of aqueous adhesives leads to problems with controlling the film thickness and dripping.

Heretofore it has been understood that rubber to substrate adhesives rely on a cross linking agent in the covercoat such as dinitrosobenzene (DNB). However, DNB is difficult to manufacture due to the explosive nature of one of its precursors. Additionally, the presence of DNB in the adhesive is known to cause problems, such as mold fouling or rubber pre-curing, when parts are subjected to a prebake or otherwise heated prior to bonding. It would therefore further be advantageous to provide a rubber to substrate adhesive which does not rely on a crosslinking agent in the outer adhesive layer. It would be particularly desirable to provide an adhesive which can be heated to relatively high temperatures (around 400° F.) and still maintain good bonding and corrosion resistance.

### SUMMARY OF THE INVENTION

The present invention provides a two coat adhesive system for rubber to metal bonding applications which is particularly well suited for high temperature molding of SBR compounds. The adhesive system may optionally be baked without deteriorating the strength of the bond. Surprisingly, when baked at 400° F. for 10 minutes the adhesive system provides both salt fog corrosion resistance up to 1000 hours. Additionally, the adhesive system after the bake provides excellent rubber tearing bonds to synthetic rubber compounds.

In one embodiment of the present invention a two layer adhesive system is provided comprising an undercoat comprising a flexibilizer, a phenolic resin, an acid, and a corrosion inhibitor; and a covercoat comprising an aqueous phenolic resin, and an aqueous butadiene polymer latex.

In another embodiment of the present invention, an aqueous adhesive system is provided comprising two layers. The adhesive system, once processed, properly provides exceptional bonding to rubber and metal and also provides excellent corrosion resistance.

The aqueous adhesive system of embodiments of the present invention provide a number of features and advantages over the prior art. The system is completely autodepositable and easy to apply at specific film thickness. The adhesive properties greatly improve after a bake cycle at high temperature, which usually cause adhesives to lose effectiveness. The adhesive system develops a black color that is desirable during and after the bake and provides a visual indicator of the progress of the bake cycle. In prior art systems, additives such as carbon black or dyes are necessary to achieve the desired color.

The adhesive system provides excellent corrosion resistance outside the bond area, which solves corrosion issues currently experienced with prior art systems. Further, the covercoat does not require the crosslinkers of the prior art, which can lead to mold fouling and rubber pre-curing. Additionally, the aqueous system reduces air pollutants and is more environmentally friendly than prior art solvent-based systems.

A further feature of the present invention is a two-coat adhesive system wherein the covercoat provides corrosion protection and adhesive properties. The adhesive system of the present invention is particularly well suited for high temperature bonding applications.

Thus, there has been outlined, rather broadly, the more important features of the invention in order that the detailed description that follows may be better understood and in order that the present contribution to the art may be better appreciated. There are, obviously, additional features of the invention that will be described hereinafter and which will form the subject matter of the claims appended hereto. In this respect, before explaining several embodiments of the invention in detail, it is to be understood that the invention is not limited in its application to the details and construction and to the arrangement of the components set forth in the following description or illustrated in the drawings. The invention is capable of other embodiments and of being practiced and carried out in various ways.

It is also to be understood that the phraseology and terminology herein are for the purposes of description and should not be regarded as limiting in any respect. Those skilled in the art will appreciate the concepts upon which this disclosure is based and that it may readily be utilized as the basis for designating other structures, methods and systems for carrying out the several purposes of this development. It is important that the claims be regarded as including such equivalent constructions insofar as they do not depart from the spirit and scope of the present invention.

### DETAILED DESCRIPTION

Unless otherwise indicated, description of components in chemical nomenclature refers to the components at the time of addition to any combination specified in the description, but does not necessarily preclude chemical interactions among the components of a mixture once mixed.

Certain terms used in this document are defined below.

“Phenolic compound” means a compound that includes at least one hydroxy functional group attached to a carbon atom of an aromatic ring. Illustrative phenolic compounds include unsubstituted phenol per se, substituted phenols such as alkylated phenols and multi-hydroxy phenols, and hydroxy-substituted multi-ring aromatics. Illustrative alkylated phenols include methylphenol (also known as cresol), dimethylphenol (also known as xylenol), 2-ethylphenol, pentylphenol and tert-butyl phenol. “Multi-hydroxy phenolic compound” means a compound that includes more than one hydroxy group on each aromatic ring. Illustrative multi-hydroxy phenols include 1,3-benzenediol (also known as resorcinol), 1,2-benzenediol (also known as pyrocatechol), 1,4-benzenediol (also known as hydroquinone), 1,2,3-benzenetriol (also known as pyrogallol), 1,3,5-benzenetriol and 4-tert-butyl-1,2-benzenediol (also known as tert-butyl catechol). Illustrative hydroxy-substituted multi-ring aromatics include 4,4′-isopropylidenebisphenol (also known as bisphenol A), 4,4′methylidenebisphenol (also known as bisphenol F) and naphthol.

“Aldehyde compound” means a compound having the generic formula RCHO. Illustrative aldehyde compounds include formaldehyde, acetaldehyde, propionaldehyde, n-butylaldehyde, n-valeraldehyde, caproaldehyde, heptaldehyde and other straight-chain aldehydes having up to 8 carbon atoms, as well as compounds that decompose to formaldehyde such as paraformaldehyde, trioxane, furfural, hexamethylenetriamine, acetals that liberate formaldehyde on heating, and benzaldehyde.

“Phenolic resin” generally means the reaction product of a phenolic compound with an aldehyde compound. The molar ratio of the aldehyde compound (for example, formaldehyde) reacted with the phenolic compound is referred to herein as the “F/P ratio”. The F/P ratio is calculated on a per hydroxy-substituted aromatic ring basis.

“Phenolic resin precursor” means an unmodified or conventional phenolic resin that is reacted with the aromatic modifying agent to produce the phenolic resin that is dispersed in an aqueous phase.

In a first embodiment of the present invention, the flexibilizer or film-former comprises any ingredient that forms a film and/or any material that contributes flexibility and/or toughness to the film formed from the composition. The toughness provided by the flexibilizer provides fracture resistance to the film. The flexibilizer should be non-glassy at ambient temperature and an aqueous emulsion latex or aqueous dispersion that is compatible with the other components of the adhesive. The flexibilizer preferably is formulated into the adhesive composition in the form of an aqueous emulsion latex or aqueous dispersion.

Suitable flexibilizers include aqueous latices, emulsions or dispersions of (poly)butadiene, neoprene, styrene-butadiene rubber, acrylonitrile-butadiene rubber (also known as nitrile rubber), halogenated polyolefin, acrylic polymer, urethane polymer, ethylene-propylene copolymer rubber, ethylene-propylene-diene terpolymer rubber, styrene-acrylic copolymer, polyamide, poly(vinyl acetate) and the like. Halogenated polyolefins, nitrile rubbers and styrene-acrylic copolymers are preferred.

A suitable styrene-acrylic polymer latex is described, for example, in U.S. Pat. Nos. 4,968,741; 5,122,566 and 5,616,635. According to U.S. Pat. No. 5,616,635, such a copolymer latex is made from 45-85 weight percent vinyl aromatic monomers, 15-50 weight percent of at least one alkyl acrylate monomer and 1-6 weight percent unsaturated carbonyl compound. Styrene is the preferred vinyl aromatic monomer, butyl acrylate is the preferred acrylate monomer and acrylic acid and methacrylic acid are the preferred unsaturated carbonyl compound. The mixture for making the latex also includes at least one phosphate ester surfactant, at least one water-insoluble nonionic surface active agent and at least one free radical initiator.

In another embodiment of the present invention, the flexibilizer preferably comprises nitrile rubber mixed into the composition as an emulsion latex. It is known in the art that nitrile rubber emulsion latices are generally made from at least one monomer of acrylonitrile or an alkyl derivative thereof and at least one monomer of a conjugated diene, preferably butadiene. According to U.S. Pat. No. 4,920,176 the acrylonitrile or alkyl derivative monomer should be present in an amount of 0 or 1 to 50 percent by weight based on the total weight of the monomers. The conjugated diene monomer should be present in an amount of 50 percent to 99 percent by weight based on the total weight of the monomers. The nitrile rubbers can also optionally include various co-monomers such as acrylic acid or various esters thereof, dicarboxylic acids or combinations thereof. The polymerization of the monomers typically is initiated via free radical catalysts. Anionic surfactants typically are also added.

Representative halogenated polyolefins include chlorinated natural rubber, chlorine- and bromine-containing synthetic rubbers including polychloroprene, chlorinated polychloroprene, chlorinated polybutadiene, hexachloropentadiene, butadienethalogenated cyclic conjugated diene adducts, chlorinated butadiene styrene copolymers, chlorinated ethylene propylene copolymers and ethylene/propylene/non-conjugated diene terpolymers, chlorinated polyethylene, chlorosulfonated polyethylene, poly(2,3-dichloro-1,3-butadiene), brominated poly(2,3-dichloro-1,3-butadiene), copolymers of (x-haloacrylonitriles and 2,3-dichloro-1,3-butadiene, chlorinated poly(vinyl chloride) and the like including mixtures of such halogen-containing elastomers.

Lattices of the halogenated polyolefin can be prepared according to methods known in the art such as by dissolving the halogenated polyolefin in a solvent and adding a surfactant to the resulting solution. Water can then be added to the solution under high shear to emulsify the polymer. The solvent is then stripped to obtain a latex. The latex can also be prepared by emulsion polymerization of the halogenated ethylenically unsaturated monomers.

In another embodiment of the present invention, the flexibilizer or film-former comprises the butadiene lattices described below. In a further embodiment of the present invention, the flexibilizer or film-former is present in the adhesive in an amount of 5 to 60, preferably 20 to 30, weight percent, based on the total dry weight of all the components of the adhesive.

The phenolic resin employed in the undercoat comprises a waterborne-type resin that is compatible with the flexibilizer or film-former. Illustrative phenolic resins include water soluble phenolic resins and an aqueous phenolic resin dispersions. Phenolic resins are well-known materials and can be a novolak, a resole or a mixture thereof. Examples of phenolic resins are found in commonly assigned U.S. Pat. No. 6,130,289. The phenolic resin dispersions can be obtained by reacting or mixing a phenolic resin precursor and a modifying agent-theoretically via a condensation reaction between the phenolic resin precursor and the modifying agent.

One functional moiety of the modifying agent provides the ionic pendant group that enables stable dispersion of the phenolic resin. Without the ionic pendant group, the phenolic resin would be unable to maintain a stable dispersion in water. Since the ionic pendant group provides for the stability of the dispersion there is no need, or at the most a minimal need, for surfactants. The presence of surfactants in an aqueous composition is a well-known hindrance to the composition's performance.

The other important functional moiety in the modifying agent enables the modifying agent to react with the phenolic resin precursor. The modifying agent can contain more than one ionic pendant group and more than one reaction-enabling moiety.

Incorporation of aromatic sulfonate functional moieties into the phenolic resin structure via condensation is the preferred method of providing the ionic pendant groups. Accordingly, one class of ionic moieties is substituents on an aromatic ring that include a sulfur atom covalently or ionically bonded to a carbon atom of the aromatic ring. Examples of covalently bound sulfur-containing substituents are sulfonate (—S(O)₂O⁻M⁺), sulfinate (—S(O)O⁻M⁺), sulfenate (—SO⁻M⁺) and oxysulfonate (—OS(O)₂O⁻M⁺), wherein M can be any monovalent ion such as Na, Li, K, or NR¹₃ (wherein R¹ is hydrogen or an alkyl). Another example of a covalently bound substituent is sulfate ion. Sulfonate is the referred ionic group. The modifying agent should not include or introduce any multivalent ions into the phenolic resin dispersion since it is expected that the presence of multivalent ions would cause the phenolic resin to precipitate rather than remain dispersed.

The reaction-enabling functional moiety of the modifying agent can be any functional group that provides a site on the modifying agent for undergoing condensation with a phenolic resin. If the phenolic resin precursor is a resole, the modifying agent reacts with an alkylol or benzyl ether group of the resole. If the modifying agent is aromatic, the reaction-enabling functional moiety is a substituent on the aromatic ring that causes a site on the ring to be reactive to the alkylol or benzyl ether of the resole precursor. Examples of such a substituent are hydroxy or hydroxyalkyl, with hydroxy being preferred. The hydroxy- or hydroxyalkyl-substituted aromatic modifying agent is reactive at a site ortho and/or para to each hydroxy or hydroxyalkyl substituent. In other words, the aromatic modifying agent is bonded to, or incorporated into, the phenolic resin precursor at sites on the aromatic ring of the modifying agent that are ortho and/or para to a hydroxy or hydroxyalkyl substituent. At least two reaction-enabling functional moieties are preferred to enhance the reactivity of the aromatic modifying agent with the phenolic resin precursor.

Alternatively, the reaction-enabling functional moiety of the modifying agent can be a formyl group (—CHO), preferably attached to a carbon atom of an aromatic ring. In this instance, the phenolic resin precursor is a novolak rather than a resole. The novolak precursor is reacted via an acid catalyzed aldehyde condensation reaction with the formyl group-containing modifying agent so that the formyl group forms a divalent methylene linkage to an active site on an aromatic ring of the backbone structure of the novolak precursor. Consequently, the modifying agent structure (including the ionic moiety) is incorporated into the phenolic structure through the generated methylene linkage. Examples of such formyl group-containing modifying agents include 2-formylbenzene sulfonate, 5-formylfuran sulfonate and (R)(SO₃)CH—CH₂—C(O)(H) compounds wherein R is C₁-C₄ alkyl groups.

Another alternative reaction-enabling functional moiety could be a diazo group (—N₂⁺), preferably attached to a carbon atom of an aromatic ring. In this instance, the phenolic resin precursor is a novolak rather than a resole. The novolak precursor is reacted via a diazo coupling reaction with the diazo group-containing modifying agent so that the diazo group forms a divalent diazo linkage (—N═) to an active site on an aromatic ring of the backbone structure of the novolak precursor. Consequently, the modifying agent structure (including the ionic moiety) is incorporated into the phenolic structure through the diazo linkage. An example of such a diazo modifying agent is 1-diazo-2-naphthol-4-sulfonic acid.

The modifying agent also can optionally include a functional moiety that is capable of chelating with a metal ion that is present on a substrate surface on which the phenolic resin dispersion is applied. The chelating group remains as a residual group after the condensation of the phenolic resin precursor and the aromatic modifying agent. Typically, the chelating group is a substituent on the aromatic ring that is capable of forming a 5- or 6-membered chelation structure with a metal ion. Examples of such substituents include hydroxy and hydroxyalkyl, with hydroxy being preferred. At least two such functional groups must be present on the modifying agent molecule to provide the chelating. In the case of an aromatic modifying agent, the chelating groups should be located in an ortho position relative to each other. A significant advantage of the invention is that hydroxy or hydroxyalkyl substituents on the aromatic modifying agent can serve two roles—condensation enablement and subsequent metal chelating.

An aromatic modifying agent is particularly advantageous. Preferably, the ionic group and the reaction-enabling moiety are not substituents on the same aromatic ring. The ionic group, particularly sulfonate, appears to have a strong deactivating effect on condensation reactions of the ring to which it is attached. Consequently, an ionic group attached to the same ring as the reaction-enabling moiety would not allow the modifying agent to readily react with the phenolic resin precursor. However, it should be recognized that this consideration for the location of the ionic and reaction-enabling moieties is not applicable to the formyl group-containing modifying agent and diazo modifying agent.

A preferred structure for the aromatic modifying agent is represented by formulae Ia or Ib below: 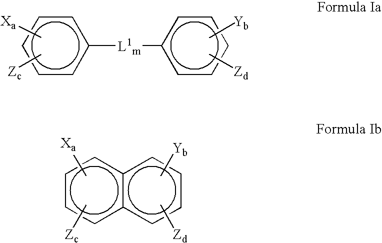
wherein X is the ionic group; Y is the reaction-enabling substituent; Z is the chelating substituent; L¹ is a divalent linking group such as an alkylene radical (for example, methylene) or a diazo (—N═N—); a is 1; b is 1 to 4; m is 0 or 1; and c and d are each independently 0 to 3, provided there are not more than 4 substituents on each aromatic ring. If a chelating group Z is present it is positioned ortho to another chelating group Z or to Y. It should be recognized that the reaction-enabling substituent Y may also act as a chelating substituent. In this instance, the aromatic modifying agent may not include an independent chelating substituent Z. An aromatic modifying agent according to formulae Ia or Ib could also include other substituents provided they do not adversely interfere with the ionic group or the condensation reaction.

Illustrative aromatic modifying agents include salts of 6,7-dihydroxy-2-napthalenesulfonate; 6,7-dihydroxy-1 -naphthalenesulfonate; 6,7-dihydroxy-4-napthalenesulfonate; Acid Red 88; Acid Alizarin Violet N; Erichrome Black T; Erichrome Blue Black B; Brilliant Yellow; Crocein Orange G; Biebrich Yellow; and Palatine Chrome Black 6BN. 6,7-dihydroxy-2-naphthalenesulfonate, sodium salt is the preferred aromatic modifying agent.

It should be recognized that the preferred sulfonate modification contemplated herein involves an indirect sulfonation mechanism. In other words, the aromatic modifying agent includes a sulfonate group and is reacted with another aromatic compound (the phenolic resin precursor) to obtain the chain extended, sulfonate-modified phenolic resin product. This indirect sulfonation is distinctly different than direct sulfonation of the phenolic resin precursor.

In one embodiment of the present invention, the phenolic resin comprises a resole. The resole precursor should have a sufficient amount of active alkylol or benzyl ether groups that can initially condense with the modifying agent and then undergo further subsequent condensation. Of course, the phenolic resin precursor has a lower molecular weight than the final dispersed resin since the precursor undergoes condensation to make the final dispersed resin. Resoles are prepared by reacting a phenolic compound with an excess of an aldehyde in the presence of a base catalyst. Resole resins are usually supplied and used as reaction product mixtures of monomeric phenolic compounds and higher molecular weight condensation products having alkylol (—ArCH₂—OH) or benzyl ether termination (—ArCH₂—O—CH₂ Ar), wherein Ar is an aryl group. These resole mixtures or prepolymers (also known as stage A resin) can be transformed into three-dimensional, crosslinked, insoluble and infusible polymers by the application of heat.

The reactants, conditions and catalysts for preparing resoles suitable for the resole precursor of the present invention are well known. The phenolic compound can be any of those previously listed or other similar compounds, although multi-hydroxy phenolic compounds are undesirable. Particularly preferred phenolic compounds for making the resole precursor include phenol per se and alkylated phenol. The aldehyde also can be any of those previously listed or other similar compounds, with formaldehyde being preferred. Low molecular weight, water soluble or partially water soluble resoles are preferred as the precursor because such resoles maximize the ability to condense with the modifying agent. The F/P ratio of the resole precursor should be at least 0.90.

As described above, the dispersed phenolic resin reaction product according to the invention can be hydrophilic or hydrophobic, but hydrophilic is preferred. In addition, dispersed resoles or novolaks can be obtained depending upon the selection and amount of reactants.

Preferably, the dispersed resole is produced by reacting or mixing 1 mol of modifying agent(s) with 1 to 20 mol of phenolic resin precursor(s). A dispersed resole typically can be obtained by reacting or mixing a resole precursor or a mixture of resole precursors with the modifying agent or a mixture of agents without any other reactants, additives or catalysts. However, other reactants, additives or catalysts can be used as desired. Multi-hydroxy phenolic compound(s) can optionally be included in relatively small amounts in the reactant mixture for the resole.

Hydrophilic resoles typically have a F/P ratio of at least 1.0. According to the invention, hydrophilic resoles having a F/P ratio much greater than 1.0 can be successfully dispersed. For example, it is possible to make an aqueous dispersion of hydrophilic resoles having a F/P ratio of at least 2 and approaching 3, which is the theoretical F/P ratio limit.

In another embodiment of the present invention, the phenolic resin comprises a novolak. Preferably, the dispersed novolak is produced by reacting 1 mol of modifying agent(s) with 2-20 mol of phenolic resin precursor(s) and, preferably, 2-20 mol of multi-hydroxy phenolic compound(s). An aldehyde compound, preferably formaldehyde, is also required to make the novolak. The aldehyde compound can optionally be added as a separate ingredient in the initial reaction mixture or the aldehyde compound can be generated in situ from the resole precursor. The resole precursor(s), multi-hydroxy phenolic compound(s) and modifying agent(s) co-condense to form the dispersed novolak. The reaction typically is acid catalyzed with an acid such as phosphoric acid. The F/P ratio of aldehyde compound(s) to combined amount of resole precursor(s) and multi-hydroxy phenolic compound(s) in the initial reaction mixture preferably is less than 0.9. Preferably, synthesis of the dispersed novolak is a two stage reaction. In the first stage, the resole precursor(s) is reacted with the modifying agent(s) and, optionally, a small amount of multi-hydroxy phenolic compound(s). Once this first stage reaction has reached the desired point (i.e. the resin can be readily formed into a translucent dispersion), the acid catalyst and a greater amount of multi-hydroxy phenolic compound(s) is added to the reaction mixture. Pyrocatechol (also simply known as catechol) is a preferred multi-hydroxy phenolic compound for reacting in the first stage and resorcinol is a preferred multi-hydroxy phenolic compound for reacting in the second stage.

Hydrophilic novolaks typically have a hydroxy equivalents of between 1 and 3 per aromatic ring. Preferably, dispersed hydrophilic novolaks according to the invention have a hydroxy equivalents of 1.1 to 2.5, more preferably 1.1 to 2.0. The hydroxy equivalents is calculated based on the amount of multi-hydroxy phenolic compounds used to make the novolak.

According to a preferred embodiment, the dispersed phenolic resin reaction product contains a mixture of oligomers having structures believed to be represented by the following formulae IIa or IIb: 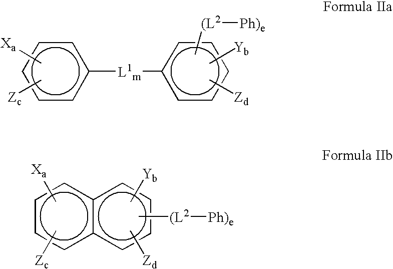
wherein X, Y, Z and L¹ and subscripts a, b, c, d and m are the same as in formulae Ia and Ib, e is 1 to 6, L² is a divalent linking group and Ph is the phenolic resin backbone structure, provided the -(L²-Ph) group(s) is(are) ortho or para to a Y group. L² depends upon the particular phenolic resin, but typically is a divalent alkylene radical such as methylene (—CH₂—) or oxydimethylene (—CH₂—O—CH₂—). Preferably, e is 2 and the -(L²-Ph) groups are in para position to each other.

In one embodiment of the present invention, phenolic resin comprises a resole and the modifying agent comprises a naphthalene having a ionic pendant group X and two reaction-enabling substituents Y, the dispersed phenolic resin reaction product contains a mixture of oligomers having structures believed to be represented by the following formula III: 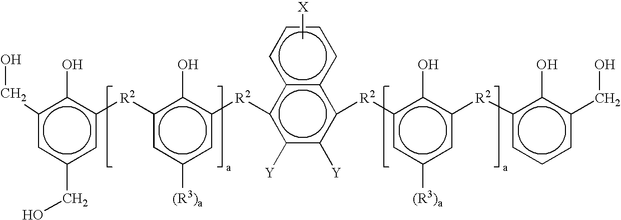
wherein X and Y are the same as in formulae Ia and Ib, a is 0 or 1; n is 0 to 5; R² is independently —C(R⁵)₂— or —C(R⁵)₂—O—C(R⁵)₂—, wherein R⁵ is independently hydrogen, alkylol, hydroxyl, alkyl, aryl or aryl ether; and R³ is independently alkylol, alkyl, aryl, alkylaryl or aryl ether. Preferably, R² is methylene or oxydimethylene and R³ is methylol. If 6,7-dihydroxy-2-naphthalenesulfonate, sodium salt is the modifying agent, X will be SO₃⁻Na⁺ and each Y will be OH. It should be recognized that in this case the hydroxy groups for Y will also act as chelating groups with a metal ion.

According to another embodiment of the present invention, wherein the phenolic resin comprises a novolak and the modifying agent comprises a naphthalene having a ionic pendant group X and two reaction-enabling substituents Y, the dispersed phenolic resin reaction product contains a mixture of oligomers having structures believed to be represented by the following formula IV: 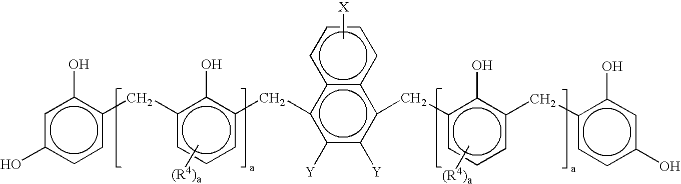
wherein X and Y are the same as in formulae Ia and Ib, a is 0 or 1, n is 0 to 5 and R⁴ is independently hydroxyl, alkyl, aryl, alkylaryl or aryl ether. Preferably, R⁴ is tert-butyl. If 6,7-dihydroxy-2-naphthalenesulfonate, sodium salt is the modifying agent, X will be SO₃^{‘}Na.⁺ and each Y will be OH. In this case the hydroxy groups for Y will also act as chelating groups with a metal ion.

It should be recognized that the dispersed phenolic resin reaction product may contain oligomers or compounds having structures that vary from the idealized structures shown in formulae III and IV.

If the modifying agent includes a sulfur-containing ionic group, the resulting modified phenolic resin should have a carbon/sulfur atom ratio of 20:1 to 200:1, preferably 20:1 to 100:1. If the sulfur content is greater than the 20:1 carbon/sulfur atom ratio, the modified phenolic resin begins to become water-soluble, is more stable with respect to multivalent ions and is difficult to thermoset. These characteristics are adverse to the preferred use of the phenolic resin dispersion of the invention. If the sulfur content is below the 200:1 carbon/sulfur atom ratio, then the resin dispersion cannot maintain its stability. Viewed another way, the dispersed phenolic resins have 0.01 to 0.10, preferably 0.03 to 0.06, equivalents of sulfonate functionality/100 g resin. The aqueous dispersion of the phenolic resin preferably has a solids content of 1 to 50, preferably 15 to 30.

The modifying agent and the phenolic resin precursor can be reacted or mixed under conditions effective to promote condensation of the modifying agent with the phenolic resin precursor. The reaction is carried out in water under standard phenolic resin condensation techniques and conditions. The reactant mixture (including water) generally is heated from 50 to 100° C. under ambient pressure, although the specific temperature may differ considerably depending upon the specific reactants and the desired reaction product. The resulting product is a concentrate that is self-dispersible upon the addition of water and agitation to reach a desired solids content. The final dispersion can be filtered to remove any gelled agglomerations.

The intermediate modified resoles or novolaks that are initially produced in the synthesis are not necessarily water dispersible, but as the chain extension is advanced the resulting chain extended modified resoles or novolaks become progressively more water dispersible by simple mechanical agitation. The chain extension for the dispersed resole is determined by measuring the viscosity of the reaction mixture. Once the resole reaction mixture has a reached the desired viscosity, which varies depending upon the reactant composition, the reaction is stopped by removing the heat. The chain extension for the dispersed novolak is determined by pre-selecting the F/P ratio of the total reaction mixture (in other words, the amount of aldehyde compound(s) relative to the amount of phenolic(s) in both the first and second stages). The reaction for the novolak is allowed to proceed until substantially all of the total amount of the reactants have reacted. In other words, there is essentially no unreacted reactant remaining. Preferably, the molecular weight (i.e., chain extension) of both the resole and novolak should be advanced to just below the gel point.

The amount of the phenolic resin can range broadly depending upon the particular use of the composition. In general, the phenolic resin can be present in an amount of 5 to 90, preferably 50 to 75, weight percent.

The acid component comprises any acid that is capable of adjusting the pH of the adhesive composition to 1-3. Illustrative acids include hydrofluoric acid, phosphoric acid, sulfuric acid, hydrochloric acid and nitric acid. Aqueous solutions of phosphoric acid are preferred. When the acid is mixed into the composition presumably the respective ions are formed and exist as independent species in addition to the presence of the free acid. In other words, in the case of phosphoric acid, phosphate ions and free phosphoric acid co-exist in the formulated final multi-component composition. The acid preferably is present in an amount of 5 to 300 parts by weight, more preferably 10 to 160 parts by weight, based on 100 parts by weight of the phenolic novolak resin dispersion.

Water, preferably de-ionized water, is utilized in the adhesive composition of the invention in order to vary the solids content and to provide a carrier fluid for mixing the ingredients of the adhesive and delivering the adhesive to a substrate surface. Since the adhesive composition is waterborne, it is substantially free of volatile organic compounds.

The undercoat additionally comprises at least one corrosion inhibitor. Representative corrosion inhibitors comprise organic, inorganic, and organometallic compounds, coated or uncoated inorganic pigments such as Fe₂O₃, SiO₂ and/or TiO₂, for example, nanoparticles, aluminum phosphates, antimony compounds such as antimony hydroxide, zinc phosphates, zinc salts of aminocarboxylates, of 5-nitroisophthalic acid or cyanic acid, polymeric amino salts with fatty acids, TPA-amine complexes, phosphates and/or carbonates based on titanium or zirconium, metal salts of dodecylnaphthalenesulfonic acid, amino complexes and transition metal complexes of toluenepropionic acid, silanes, and 2-mercaptobenzothiazolylsuccinic acid and/or amino salts thereof. It is also possible to add an addition of conductive polymers, especially for reasons of corrosion control. The amount of at least one corrosion inhibitor varies preferably in the range from 0.4 to 10% by weight, more preferably in the range from 0.6 to 6% by weight.

The butadiene monomers useful for preparing the butadiene polymer latex can essentially be any monomer containing conjugated unsaturation. Typical monomers include 2,3-dichloro-1,3-butadiene; 1,3-butadiene; 2,3-dibromo-1,3-butadiene isoprene; isoprene; 2,3-dimethylbutadiene; chloroprene; bromoprene; 2,3-dibromo-1,3-butadiene; 1,1,2-trichlorobutadiene; cyanoprene; hexachlorobutadiene; and combinations thereof. It is particularly preferred to use 2,3-dichloro-1,3-butadiene since a polymer that contains as its major portion 2,3-dichloro-1,3-butadiene monomer units has been found to be particularly useful in adhesive applications due to the excellent bonding ability and barrier properties of the 2,3-dichloro-1,3-butadiene-based polymers. As described above, an especially preferred embodiment of the present invention is one wherein the butadiene polymer includes at least 60 weight percent, preferably at least 70 weight percent, 2,3-dichloro-1,3-butadiene monomer units.

The butadiene monomer can be copolymerized with other monomers. Such copolymerizable monomers include ax-haloacrylonitriles such as α-bromoacrylonitrile and α-chloroacrylonitrile; α,β-unsaturated carboxylic acids such as acrylic, methacrylic, 2-ethylacrylic, 2-propylacrylic, 2-butylacrylic and itaconic acids; alkyl-2-haloacrylates such as ethyl-2-chloroacrylate and ethyl-2-bromoacrylate; α-bromovinylketone; vinylidene chloride; vinyl toluenes; vinylnaphthalenes; vinyl ethers, esters and ketones such as methyl vinyl ether, vinyl acetate and methyl vinyl ketone; esters amides, and nitriles of acrylic and methacrylic acids such as ethyl acrylate, methyl methacrylate, glycidyl acrylate, methacrylamide and acrylonitrile; and combinations of such monomers. The copolymerizable monomers, if utilized, are preferably α-haloacrylonitrile and/or α,β-unsaturated carboxylic acids. The copolymerizable monomers may be utilized in an amount of 0.1 to 30 weight percent, based on the weight of the total monomers utilized to form the butadiene polymer.

In carrying out the emulsion polymerization to produce the latex other optional ingredients may be employed during the polymerization process. For example, conventional anionic and/or nonionic surfactants may be utilized in order to aid in the formation of the latex. Typical anionic surfactants include carboxylates such as fatty acid soaps from lauric, stearic, and oleic acid; acyl derivatives of sarcosine such as methyl glycine; sulfates such as sodium lauryl sulfate; sulfated natural oils and esters such as Turkey Red Oil; alkyl aryl polyether sulfates; alkali alkyl sulfates; ethoxylated aryl sulfonic acid salts; alkyl aryl polyether sulfonates; isopropyl naphthalene sulfonates; sulfosuccinates; phosphate esters such as short chain fatty alcohol partial esters of complex phosphates; and orthophosphate esters of polyethoxylated fatty alcohols. Typical nonionic surfactants include ethoxylated (ethylene oxide) derivatives such as ethoxylated alkyl aryl derivatives; mono- and polyhydric alcohols; ethylene oxide/propylene oxide block copolymers; esters such as glyceryl monostearate; products of the dehydration of sorbitol such as sorbitan monostearate and polyethylene oxide sorbitan monolaurate; amines; lauric acid; and isopropenyl halide. A conventional surfactant, if utilized, is employed in an amount of 0.01 to 5 parts, preferably 0.1 to 2 parts, per 100 parts by weight of total monomers utilized to form the butadiene polymer.

In the case of dichlorobutadiene homopolymers, anionic surfactants are particularly useful. Such anionic surfactants include alkyl sulfonates and alkyl aryl sulfonates and sulfonic acids or salts of alkylated diphenyl oxide for example, didodecyl diphenyleneoxide disulfonate or dihexyl diphenyloxide disulfonate.

Chain transfer agents may also be employed during emulsion polymerization in order to control the molecular weight of the butadiene polymer and to modify the physical properties of the resultant polymer as is known in the art. Any of the conventional organic sulfur-containing chain transfer agents may be utilized such as alkyl mercaptans and dialkyl xanthogen disulfides.

The emulsion polymerization is typically triggered by a free radical initiator. Illustrative free radical initiators include conventional redox systems, peroxide systems, azo derivatives and hydroperoxide systems. The use of a redox system is preferred and examples of such systems include ammonium persulfatelsodium metabisulfite, ferric sulfate/ascorbic acid/hydroperoxide and tributylborane/hydroperoxide, with ammonium persulfate/sodium metabisulfite being most preferred.

The emulsion polymerization is typically carried out at a temperature of 10° C.-90° C., preferably 40° C.-60° C. Monomer conversion usually ranges from 70-100, preferably 80-100, percent. The latices preferably have a solids content of 10 to 70, more preferably 30 to 60, percent; a viscosity between 50 and 10,000 centipoise at 25° C.; and a particle size between 60 and 300 nanometers.

Especially preferred as the butadiene latex is a butadiene polymer that has been emulsion polymerized in the presence of a styrene sulfonic acid, styrene sulfonate, poly(styrene sulfonic acid), or poly(styrene sulfonate) stabilizer to form the latex. Poly(styrene sulfonate) is the preferred stabilizer. This stabilization system is particularly effective for a butadiene polymer that is derived from at least 60 weight percent dichlorobutadiene monomer, based on the amount of total monomers used to form the butadiene polymer. The butadiene polymer latex can be made by known emulsion polymerization techniques that involve polymerizing the butadiene monomer (and copolymerizable monomer, if present) in the presence of water and the styrene sulfonic acid, styrene sulfonate, poly(styrene sulfonic acid), or poly(styrene sulfonate) stabilizer. The sulfonates can be salts of any cationic groups such as sodium, potassium or quaternary ammonium. Sodium styrene sulfonate is a preferred styrene sulfonate compound. Poly(styrene sulfonate) polymers include poly(styrene sulfonate) homopolymer and poly(styrene sulfonate) copolymers such as those with maleic anhydride. Sodium salts of poly(styrene sulfonate) are particularly preferred. The poly(styrene sulfonate) can have a weight average molecular weight from 5×10⁴ to 1.5×10⁶, with 1.5×10⁵ to 2.5×10⁵ being preferred. In the case of a poly(styrene sulfonate) or poly(styrene sulfonic acid) it is important to recognize that the emulsion polymerization takes place in the presence of the pre-formed polymer. In other words, the butadiene monomer is contacted with the pre-formed poly(styrene sulfonate) or poly(styrene sulfonic acid). The stabilizer preferably is present in an amount of 0.1 to 10 parts, preferably 1 to 5 parts, per 100 parts by weight of total monomers utilized to form the butadiene polymer.

The aqueous phenolic resin employed in the covercoat of the present invention may be any of the novolak resins described above. Additional aqueous phenolic resins for use in the present invention include phenolic resoles. A phenolic resole is an aqueous dispersible or soluble heat-reactive condensation product of an aldehyde compound with a phenolic compound. The resoles are well-known and are typically prepared by reacting a phenolic compound with an excess of an aldehyde compound in the presence of a base catalyst. Illustrative waterborne phenolics include polyvinyl alcohol-stabilized aqueous resole dispersions; an aqueous dispersion of a heat-reactive hydrophilic phenolic resin, a hydrophobic etherified bisphenol-A resin and a protective colloid; water-soluble sulfonated phenolic resins; aqueous novolak resins; aqueous solutions of lower condensate of phenolic resins; aqueous solutions of phenolic resins containing concentrated caustic acid; aqueous emulsions of phenolic resins that include polyacrylamide; and aqueous novolak dispersions.

In a preferred embodiment of the present invention, the phenolic resin comprises a polyvinyl alcohol-stabilized aqueous dispersion of a resole. This dispersion can be prepared by a process that includes mixing the pre-formed, solid, substantially water-insoluble, phenolic resole resin; water; an organic coupling solvent; and polyvinyl alcohol, at a temperature and for a period of time sufficient to form a dispersion of the phenolic resole resin in water. Such polyvinyl alcohol-stabilized aqueous resole dispersions are produced by reacting formaldehyde with bisphenol-A in a mol ratio of 2 to 3.75 moles of formaldehyde per mole of bisphenol-A in the presence of a catalytic amount of an alkali metal or barium oxide or hydroxide condensation catalyst wherein the reaction is carried out at elevated temperatures. The condensation product is then neutralized to a pH of 3 to 8. Alcohols, glycol ethers, ethers, esters and ketones are the most useful coupling solvents. Specific examples of useful coupling solvents include ethanol, n-propanol, isopropyl alcohol, ethylene glycol monobutyl ether, ethylene glycol monoisobutyl ether, ethylene glycol monomethyl ether acetate, diethylene glycol monobutyl ether, diethylene glycol monoethyl ether acetate, propylene glycol monopropyl ether, methoxy acetone, and the like. The polyvinyl alcohol is typically prepared by hydrolysis of polyvinyl acetate. The most useful polyvinyl alcohol polymers are hydrolyzed to an extent of 85 to 91 percent and have molecular weights such that a 4 percent solids solution of the polyvinyl alcohol in water has a viscosity of 4 to 25 centipoises at 25° C. The addition of a PVA stabilized phenolic resin to a PVA stabilized diclorobutadiene latex does not exhibit the compatibility issues seen in the prior art between PVA stabilized latex and phenolic resins.

The amount of the phenolic resin can range broadly depending upon the particular use of the composition. In general, the phenolic resin can be present in an amount of 5 to 90, preferably 10 to 40, weight percent, based on the total amount of butadiene latex and phenolic resin.

Additional ingredients can be included in the adhesive composition. Such ingredients include metal oxides, inert fillers, polymeric film-forming adjuncts, surfactants, dispersing agents, wetting agents, pigments, carbon black, silica and the like.

The compositions may be prepared by any method known in the art, but are preferably prepared by combining and milling or shaking the ingredients and water in ball-mill, sand-mill, ceramic bead-mill, steel-bead mill, high speed media-mill or the like. It is preferred to add each component to the mixture in a liquid form such as an aqueous dispersion, emulsion or latex.

The undercoat and covercoat compositions are applied to a substrate surface by dipping the substrate or part into a bath of the composition. The metal substrate can reside in the adhesive composition bath for an amount of time sufficient to deposit a uniform film of desired thickness. Typically, the bath residence time is from about 5 to about 120 seconds, preferably about 10 to about 30 seconds, and occurs at room temperature. The undercoat composition typically is applied to form a dry film thickness of 10 to 30 μm, and the covercoat composition typically is applied to form a dry film thickness of 5 to 25 μm, preferably about 15 μm. Once both coatings are autodeposited on the substrate, the substrate is baked to develop desired film adhesion properties. Typical bakes occur at temperatures of 300° F. to 500° F., preferably about 400° F., and for times of 5 to 20 minutes, preferably about 10 minutes. The time and temperature of the bake can depend on the mass of the part, efficiency of the oven, and type of oven.

### EXAMPLES

UNDERCOAT: An undercoat in the two-layer adhesive system of the present invention was prepared by mixing together the following ingredients in amounts of dry weight percent:
51.6% phenolic novolak resin
34.4% nitrile rubber latex
4.0% 5-nitroisophthalic acid, and
10% phosphoric acid.

COVERCOAT: A covercoat in the two-layer adhesive system of the present invention was prepared by mixing together the following ingredients in amounts of dry weight percent and adjusting to 30% solids in water:

| | |
|---|---|
| 70% | 95/5 DCD/ALPHA BRAN COPOLYMER (manufactured by |
| | LORD Corporation) |
| 30% | GPRI 4001 PVA stabilized phenolic resole (manufactured by |
| | Georgia Pacific) |

Procedure: 2 inch by 3.5 inch steel panels were dipped in the undercoat using a 30inch immersion and dynamic dip technique and allowed to dry. Once dry, they were dipped in the covercoat, and then heated in a 150° F. oven to flash off any remaining water. The dry adhesive coated panels were then heated to accelerate the adhesive for 10 minutes in a 400° F. oven turning the rack in the oven after 5 minutes for even heat distribution. Once the panels cooled they were bonded to an elastomer

Testing: General Parameters:
Undercoat is applied at 0.3 mils (dry film thickness (DFT))
Covercoat is applied at 0.4 mils DFT
All samples were heat accelerated for 10 minutes at 400° F. rotating the parts after 5 min.
Panel A (SBR)—cured at 400° F., Primary adhesion (180 degree peel on Scott tester)
Panel B (SBR)—cured at 400° F., Primary adhesion (180 degree peel on Scott tester)
Panel C (EPDM)—cured at 400° F., Primary adhesion (180 degree peel on Scott tester)

Compression Mold (T90+10 min)

Results

| Panel | Pre Bake | Results |
|---|---|---|
| A (SBR) | 0 minute | 100% R |
| A (SBR) | 0 minute | 100% R |
| A (SBR) | 5 minute | 100% R |
| A (SBR) | 5 minute | 100% R |
| B (SBR) | 0 minute | 100% R |
| B (SBR) | 0 minute | 100% R |
| B (SBR) | 5 minute | 100R |
| B (SBR) | 5 minute | 100R |
| C (EPDM) | 0 minute | RC |
| C (EPDM) | 0 minute | RC |
| C (EPDM) | 5 minute | RC |
| C (EPDM) | 5 minute | RC |

Where R is the percent rubber retained on the part after testing (100% R being the best bond where there is 100% failure of the rubber). RC stands for rubber to cement failure and indicates where the location of the failure occurred.

Although the present invention has been described with reference to particular embodiments, it should be recognized that these embodiments are merely illustrative of the principles of the present invention. Those of ordinary skill in the art will appreciate that the apparatus and methods of the present invention may be constructed and implemented in other ways and embodiments. Accordingly, the description herein should not be read as limiting the present invention, as other embodiments also fall within the scope of the present invention.

1. A two coat adhesive system comprising:
an undercoat comprising a flexibilizer, a phenolic resin, and an acid; and,
a covercoat comprising an aqueous phenolic resin, and an aqueous butadiene polymer latex prepared by emulsion polymerization of at least one butadiene monomer in the presence of a polyvinvyl alcohol.

2. The two coat adhesive system of claim 2, wherein the undercoat further comprises a corrosion inhibitor.

3. The two coat adhesive system of claim 1, wherein the corrosion inhibitor comprises 5-nitroisophthalic acid.

4. The two coat adhesive system of claim 1, wherein the acid comprises phosphoric acid.

5. The two coat adhesive system of claim 1, wherein the aqueous phenolic resin in the covercoat comprises a polyvinyl alcohol stabilized aqueous dispersion of a resole.

6. The two coat adhesive system of claim 1, wherein the phenolic resin in the undercoat comprises a novolak resin.

7. The two coat adhesive system of claim 1, wherein the phenolic resin in the undercoat comprises a reaction product of:
(a) a phenolic resin precursor; and
(b) a modifying agent wherein the modifying agent comprises:
(i) at least one functional moiety that enables the modifying agent to react with the phenolic resin precursor; and,
(ii) at least one ionic moiety.

8. The two coat adhesive system of claim 1, wherein the flexibilizer comprises nitrile rubber latex.

9. The two coat adhesive system of claim 1, wherein the butadiene polymer is prepared through polymerization of 2,3-dichloro-1,3-butadiene.

10. The two coat adhesive system of claim 1, wherein the butadiene polymer is prepared by copolymerization of dichlorobutadiene with at least one copolymerizable monomer.

11. The two coat adhesive system of claim 10, wherein the copolymerizable monomer comprised an α-haloacrylonitrile.

12. The two coat adhesive system of claim 1, wherein the covercoat is substantially free of a cross linking agent.

13. The two coat adhesive system of claim 1, wherein the covercoat is substantially free of dinitrosobenzene.

14. The two coat adhesive system of claim 1, wherein the covercoat thickness ranges from 0.2 to 1.0 mils.

15. A method for bonding together two substrates, one of said two substrates comprises a surface containing an electrochemically active metal, said method comprising autodepositing on said metallic substrate an undercoat composition comprising a flexibilizer, a phenolic novolak resin, an acid, and a corrosion inhibitor; drying the undercoat composition; autodepositing a covercoat composition comprising an aqueous phenolic resin, and an aqueous butadiene polymer latex, drying the covercoat composition, and contacting the other of said two substrates with said adhesive-coated one of said two substrates for sufficient time for bonding said two substrates together.

16. The method of claim 15, wherein the other of said two substrates is an elastomeric material.

17. The method according to claim 15, further comprising the step of heating the adhesive-coated coated metallic substrate for approximately 10 minutes at 400° F. prior to contacting the other of said two substrates.

18. The method of claim 15, wherein the acid comprises hydrofluoric acid, phosphoric acid, sulfuric acid, hydrochloric acid or nitric acid.

19. The method of claim 15, wherein the acid comprises phosphoric acid.

20. The method of claim 15, wherein the undercoat and covercoat compositions additionally comprise water and are substantially free of volatile organic compounds.

21. The method of claim 15, dipping the metallic substrate into the undercoat and covercoat compositions to effect autodeposition of the adhesive composition.

22. The method of claim 15, wherein the dipping is performed at room temperature.
